(19) United States
(12) Patent Application Publication
(10) Pub. No.: US 2012/0052435 A1
(43) Pub. Date: Mar. 1, 2012

(54) TIN-ZINC COMPLEX OXIDE POWDER, METHOD FOR PRODUCING THE SAME, ELECTROPHOTOGRAPHIC CARRIER, AND ELECTROPHOTOGRAPHIC DEVELOPER

(75) Inventors: Kazunori ANAZAWA, Kanagawa (JP); Tomoko MIYAHARA, Kanagawa (JP); Kaoru TORIKOSHI, Kanagawa (JP)

(73) Assignee: FUJI XEROX CO., LTD., Tokyo (JP)

(21) Appl. No.: 13/109,477

(22) Filed: May 17, 2011

(30) Foreign Application Priority Data
Aug. 25, 2010 (JP) 2010-188351
Dec. 9, 2010 (JP) 2010-275026

(51) Int. Cl. G03G 9/00; C01G 19/02; B82Y 30/00

(52) U.S. Cl. 430/111.35; 423/594.9; 428/402; 977/773

(57) ABSTRACT

A tin-zinc complex oxide powder includes particles containing a tin-zinc complex oxide and having a volume resistivity of about 1×10⁵ Ω·cm or less.

### CROSS-REFERENCE TO RELATED APPLICATIONS

This application is based on and claims priority under 35 USC 119 from Japanese Patent Application No. 2010-188351 filed Aug. 25, 2010 and Japanese Patent Application No. 2010-275026 filed Dec. 9, 2010.

### BACKGROUND

(i) Technical Field

The present invention relates to a tin-zinc complex oxide powder, a method for producing the tin-zinc complex oxide powder, an electrophotographic carrier, and an electrophotographic developer.

(ii) Related Art

A carrier used in a two-component developer for electrophotographic image formation has a core and a coating layer on the surface of the core and being made of a resin material. In order to adjust the electrical resistance of the coating layer, a conductive powder is dispersed in a resin component. Examples of the conductive powder include carbon black, metal powder, and metal oxide powder. Carbon black has been widely used.

### SUMMARY

According to an aspect of the invention, there is provided a tin-zinc complex oxide powder including particles containing a tin-zinc complex oxide and having a volume resistivity of about 1×10⁵ Ω·cm or less.

### BRIEF DESCRIPTION OF THE DRAWINGS

Exemplary embodiments of the present invention will be described in detail based on the following figures, wherein:

FIG. 1 is a schematic diagram showing an example of an image forming apparatus that uses an electrophotographic developer according to an exemplary embodiment; and

FIG. 2 is a schematic diagram showing an example of a process cartridge that uses an electrophotographic developer according to an exemplary embodiment.

### DETAILED DESCRIPTION

Exemplary embodiments of an electrophotographic carrier and an electrophotographic developer are described below in detail.

### [Tin-Zinc Complex Oxide Powder]

A tin-zinc complex oxide powder according to an exemplary embodiment has a volume resistivity of 1×10⁵ Ω·cm or less or about 1×10⁵ Ω·cm or less.

Note that “powder” refers to a large number of solid particles in a gathered state. The average particle size (area-average particle size) is preferably 10 to 5000 nm or about 10 to 5000 nm and more preferably 10 to 1000 nm.

The area-average particle size is determined from a scanning electron microscopy (SEM) image. In particular, the area-average particle size is determined by measuring the particle size of 50 to 100 particles in the SEM image and averaging the observed values.

### —Lowering the Resistivity of Tin-Zinc Complex Oxide Powder—

Although a tin-zinc complex oxide powder usually has a light-color, the resistivity thereof is high. The method for lowering the resistivity of the tin-zinc complex oxide powder to a degree that imparts a sufficient electrical resistance while keeping the light color is not particularly limited. For example, this is achieved by heat-treatment in a reduced-pressure. Heat treatment under reduced pressure decreases the resistivity of the tin-zinc complex oxide powder and a tin-zinc complex oxide powder having a volume resistivity within the desired range (i.e., 1×10⁵ Ω·cm or less or about 1×10⁵ Ω·cm or less) while keeping the light color is obtained.

### —Volume Resistivity—

The volume resistivity of the tin-zinc complex oxide powder is more preferably 1×10⁴ Ω·cm or less and yet more preferably 1×10³ Ω·cm or less.

The volume resistivity of the tin-zinc complex oxide powder is measured with a powder resistivity meter (MCP-PD51) produced by Mitsubishi Chemical Analytech Co., Ltd., under the following measuring conditions.

### (Measuring Conditions)

Application voltage limiter: 90 V

Probe used: four-point probe (interelectrode distance: 3.0 mm, electrode radius: 0.7 mm, sample radius: 10.0 mm)

Load: 4.00 kN, Pressure: 12.7 MPa

The figures described in this specification are determined by this method.

### —Production Method—

Examples of the tin-zinc complex oxide powder include, but are not limited to, ZnSnO₃ and Zn₂SnO₄.

The method for controlling the volume resistivity of the tin-zinc complex oxide powder to the range of 1×10⁵ Ω·cm or less or about 1×10⁵ Ω·cm or less is not particularly limited. Examples thereof include a method of heat-treating the powder under reduced pressure. In particular, a tin-zinc complex oxide powder is preferably heat-treated at a temperature of 450° C. to 900° C. or about 450° C. to 900° C., more preferably 450° C. to 600° C., and most preferably 500° C. to 600° C.

The pressure is preferably reduced to a degree of vacuum of 10 Pa to 3 kPa or about 10 Pa to 3 kPa, more preferably 180 Pa to 3 kPa, and most preferably 670 Pa to 3 kPa.

The degree of vacuum during the heat treatment is measured with a vacuum meter connected to a crystal ion gauge installed in a port of a vacuum heat treatment furnace. The figures described in the specification are measured by this method.

The time for heat treatment is preferably 0.5 hours or more and more preferably 2 hours or more.

The tin-zinc complex oxide powder may be amorphous or substantially amorphous.

When the tin-zinc complex oxide powder is amorphous or substantially amorphous, the resistivity is easily lowered and the powder is smoothly pulverized. Thus, the size of the particles is easily reduced. As discussed in detail below, in the case where the tin-zinc complex oxide powder is to be added to the coating layer of the carrier to function as a conductive agent, the coating layer is usually controlled to a thickness in the range of 0.5 to 5 μm or about 0.5 to 5 μl. Thus, the size of the conductive agent to be added to the layer may be small.

Whether the tin-zinc complex oxide powder is amorphous or substantially amorphous or not may be identified by X-ray diffractometry.

In order to control the tin-zinc complex oxide powder to amorphous or substantially amorphous, the temperature during drying and heat treatment may be controlled to a temperature equal to or less than the crystallization temperature, for example.

The color of the tin-zinc complex oxide powder is preferably a light color. In particular, the color preferably has a color difference ΔE of 20 or less and more preferably 10 or less. The lower limit is not particularly limited and is preferably as low as possible.

### —Method for Measuring Color Difference ΔE—

In a 0.1 mg/ml polyester resin solution, a 0.1 mg/ml solution of a conductive agent sample is added to prepare a sample solution. The sample solution is subjected to suction filtration through a filter produced by Millipore K.K. (diameter: 47 mm, pore diameter: 0.05 μm, cellulose) to form a toner binder layer (area: 10 cm²). The the toner binder layer is air-dried and thermally fixed at 120° C. to prepare a color evaluation patch sample. The color of the color evaluation patch sample is measured with x-rite939 (produced by X-Rite, Incorporated). The color of the aforementioned filter produced by Millipore K.K. only is also measured as a reference. The color difference ΔE between the reference and the color evaluation patch sample is calculated from equation (1) below:

ΔE=((ΔL*)²+(Δa*)²+(Δb*)²)^{1/2} equation (1)

(in equation (1), ΔL*=L*_{reference}−L*ₛₐₘₚₗₑ, Δa*=a*_{reference}−a*ₛₐₘₚₗₑ, and Δb*=b*_{reference}−b*ₛₐₘₚₗₑ.)

### [Electrophotographic Carrier]

An electrophotographic carrier according to an exemplary embodiment is described in detail next.

An electrophotographic carrier according to an exemplary embodiment (hereinafter also referred to as “carrier”) includes a core containing a magnetic material and a coating layer coating the core. The coating layer contains a tin-zinc complex oxide powder having a volume resistivity of 1×10⁵ Ω·cm or less or about 1×10⁵ Ω·cm or less.

When carbon black is used as the conductive agent contained in the coating layer of the carrier, the coating layer also has a dark color since the carbon black has a dark color. In mixing the carrier and a toner in a developing device, impact is applied to the carrier and thus flaking of the coating layer may occur. The flaked coating layer is carried on an image portion or a non-image portion along with the toner during development. As a result, image defect, such as color spots and color dullness, occur due to the flaked dark-colored coating layer.

In contrast, the carrier of the exemplary embodiment, in particular, a carrier that includes a coating layer that contains a light-color tin-zinc complex oxide powder obtained by the aforementioned method, contains a tin-zinc complex oxide powder having a low resistivity but enough to impart a sufficient electrical resistance to the coating layer. Since the tin-zinc complex oxide powder has a light color, a coating layer having a light color is obtained while the electrical resistance required for the carrier is retained. Since the coating layer has a light color, flaking of the coating layer is not likely to cause color spots and color dullness in a formed image.

### <Coating Layer>

### (Conductive Agent)

The tin-zinc complex oxide powder of the exemplary embodiment having a volume resistivity of 1×10⁵ Ω·cm or less or about 1×10⁵ Ω·cm or less is used as a conductive agent contained in the coating layer, as described above.

—Conductive Agents that may be Used in Combination—

Conductive agents other than the tin-zinc complex oxide powder may be used in combination in the coating layer of the exemplary embodiment.

Examples of the conductive agents include tin oxide (SnO₂), zinc oxide, metals (e.g., gold, silver, and copper), carbon black, titanium oxide, barium sulfate, aluminum borate, and potassium titanate. Metal nano particles may be used in combination as a conductive agent. Metal nano particles are metal particles each having a nanometer order size. Examples of the nanometer particles include metal (including alloy) or metal oxide particles. Examples of the material for the metal nano particles include a single metal, an alloy, or an oxide of at least one element selected from group 8, 9, 10, 11, 12, 13, 14, and 15 elements in the periodic table, a metal such as Au, Ag, Cu, Pt, Ni, and Al, an alloy of at least two metals selected from Au, Ag, Cu, Pt, Ni, Al, Sn, Bi, Zn, Fe, and Co, and an oxide of a metal selected from Ag, Cu, Pt, Ni, Al, Sn, Bi, Zn, Fe, and Co. The metal, alloy, or metal oxide may be doped with Ga, Al, Tb, Nb, or the like.

Among these, tin oxide (SnO₂) may be used as a conductive agent used in combination.

### (Resin)

The resin contained in the coating layer may be any resin that may be used as a matrix resin and is selected according to usage. Examples of the resin include polyolefin resins such as polyethylene and polypropylene; polyvinyl resin and polyvinylidene resin such as polystyrene, acrylic resin, polyacrylonitrile, polyvinyl acetate, polyvinyl alcohol, polyvinyl butyral, polyvinyl chloride, polyvinyl carbazole, polyvinyl ether, and polyvinyl ketone; vinyl chloride-vinyl acetate copolymers; styrene-acrylic acid copolymers; straight silicone resins constituted by organosiloxane bonds and modified products thereof; fluorine resins such as polytetrafluoroethylene, polyvinyl fluoride, polyvinylidene fluoride, and polychlorotrifluoroethylene; silicone resins; polyesters; polyurethanes; polycarbonates; phenolic resins; amino resins such as urea-formaldehyde resins, melamine resins, benzoguanamine resins, urea resins, and polyamide resins; and epoxy resins. These may be used alone or in combination.

### <Core>

The material for the core is not particularly limited and examples thereof include magnetic metal particles such as iron, steel, nickel, and cobalt; alloys of magnetic metals with manganese, chromium, or rare earth elements; magnetic oxide particles such as ferrite and magnetite; and magnetic particle-dispersion type material that contains magnetic particles and a binder resin.

The ferrite may be a mixture with a metal such as Mn, Ca, Li, Mg, Cu, Zn, Sr, or the like.

The volume electrical resistivity of the core is, for example, in the range of 1×10⁵ Ω·cm to 1×10¹⁰ Ω·cm or about 1×10⁵ Ω·cm to 1×10¹⁰ Ω·cm.

The volume electrical resistivity is a value determined by the following method. A container having a cross-sectional area of 2×10⁻⁴ m² is filled with a core in a room temperature, room humidity (temperature: 20° C., humidity: 50% RH) environment so that the thickness of the core is 1 mm. Then a load of 1×10⁴ kg/m² is applied on the core by using a metal member. A voltage that generates an electric field having a strength of 10⁶ V/m is applied between the metal member and an electrode at the bottom of the container and the value calculated from the observed current value is assumed to be the volume electrical resistivity.

The volume-average particle size of the core is preferably 10 μm to 500 μm, more preferably 30 μm to 150 μm or about 30 μm to 150 μm, and most preferably 30 μm to 100 μm.

The volume-average particle size is a value observed with a laser diffraction/scattering-type particle size distribution meter (LS Particle Size Analyzer: LS13 320, produced by BECKMAN COULTER). The measured particle size distribution is plotted versus divided particle size ranges (channels) to draw a cumulative distribution for the volume from a small size side. The particle size at which 50% accumulation is given is defined as the volume-average particle size.

### <Method for Producing Carrier>

The method for producing the carrier of the exemplary embodiment is not particularly limited. A method such as a dry method or a wet method may be employed. A dry method is particularly preferable.

An example of a method for producing the carrier according to the exemplary embodiment is described below.

One example of a method for forming a coating layer includes mixing a raw material for the resin, the tin-zinc complex oxide powder used as a conductive agent, and other components (e.g., a conductive agent to be used in combination) to prepare a solution (coating layer forming solution), applying the solution onto the core, and heating the applied solution.

After the coating layer forming solution is applied to the surface of the core, the applied solution is heated to 70° C., for example, and then to 130° C. to cure the resin and form the coating layer.

The method for applying the coating layer forming solution to the surface of the core is not particularly limited. Examples of the method include a dipping method by which the core is dipped in the coating layer forming solution, a spraying method by which the coating layer forming solution is sprayed over the surface of the core material, a fluid bed method by which a coating layer forming solution is sprayed while having the core floating by using a flowing air; and a kneader coater method by which the core and the coating layer forming solution are mixed in a kneader coater and the solvent is removed.

The thickness of the coating layer thus formed is preferably in the range of 0.5 μm to 5 μm or about 0.5 μm to 5 μm, and more preferably in the range of 1 μm to 3 μm.

### [Electrophotographic Developer]

An electrophotographic developer (hereinafter may be referred to as “developer”) according to an exemplary embodiment is described below. The developer of the exemplary embodiment includes the aforementioned carrier and a toner.

The mixing ratio (mass ratio) of the toner to the carrier is preferably in the range of toner:carrier=1:100 to 20:100 and more preferably in the range of toner:carrier=3:100 to 15:100.

A commonly used toner may be used as the toner. The method for producing the toner is also not particularly limited. Examples of the method for producing the toner include a kneading/pulverizing method by which components such as a binder resin, a colorant, a releasing agent, a charge controlling agent, etc., are kneaded, pulverized, and classified, a method by which the shape of particles obtained by the kneading/pulverizing method is changed by applying mechanical impact or thermal energy, an emulsion polymerization/agglomeration method by which a polymerizable monomer of a binder resin is polymerized by emulsification, the resulting dispersion is mixed with a dispersion containing a colorant, a releasing agent, a charge controlling agent, etc., and aggregation and coalescence are conducted to obtain toner particles, a suspension polymerization method by which a solution containing a polymerizable monomer for obtaining a binder resin, a colorant, a releasing agent, a charge controlling agent, etc., is suspended in an aqueous solvent, and a dissolution/suspension method by which a solution containing a binder resin, a colorant, a releasing agent, a charge controlling agent, etc., is suspended in an aqueous solvent to conduct granulation. The toner obtained as above may be further coated with aggregated particles and coalesced to form a core-shell structure.

Among these methods, a suspension polymerization method that uses an aqueous solvent, an emulsion polymerization/aggregation method, and a dissolution/suspension method are preferable, and an emulsion polymerization/aggregation method is particularly preferable.

The toner may include a releasing agent in addition to a binder resin and a colorant. If needed, silica and a charge controlling agent may be used. The volume-average particle size of the toner is preferably 2 μm to 12 μm and more preferably 3 μm to 9 μm.

The volume-average particle size of the toner is determined by drawing a cumulative distribution for the volume from a small size side by using a LS Particle Size Analyzer (produced by Coulter) and assuming the particle size at which 50% accumulation is given to be the volume-average particle size.

Examples of the binder resin include a homopolymer and a copolymer of a styrene compound, such as styrene and chlorostyrene, monoolefins such as ethylene, propylene, butylene, and isoprene, vinyl esters such as vinyl acetate, vinyl propionate, vinyl benzoate, and vinyl butyrate, α-methylene fatty monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl ethers such as vinyl methyl ether, vinyl ethyl ether, and vinyl butyl ether, and vinyl ketones such as vinyl methyl ketone, vinyl hexyl ketone, and vinyl isopropenyl ketone. Representative examples of the binder resin among these include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene and polypropylene. Other examples of the binder resin include polyesters, polyurethanes, epoxy resins, silicone resins, polyamides, modified rosins, and paraffin wax.

Examples of the colorant include magnetic powders such as magnetite and ferrite, carbon black, aniline blue, Calco Oil blue, chrome yellow, ultramarine blue, DuPont oil red, quinoline yellow, methylene blue chloride, phthalocyanine blue, malachite green oxalate, lamp black, rose bengal, C. I. Pigment Red 48:1, C. I. Pigment Red 122, C. I. Pigment Red 57:1, C. I. Pigment Yellow 97, C. I. Pigment Yellow 17, C. I. Pigment Blue 15:1, and C. I. Pigment Blue 15:3.

Examples of the releasing agent include a low-molecular-weight polyethylene, low-molecular-weight polypropylene, Fischer-Tropsch wax, montan wax, carnauba wax, rice wax, and candelilla wax.

A known charge controlling agent is used as the charge controlling agent. Examples thereof include azo-based metal complex compounds, metal complex compounds of salicylic acid, and resin-type charge controlling agents containing polar groups. Note that raw materials that do not easily dissolve in water may be used in making the toner by a wet method.

The toner used in this exemplary embodiment may be a magnetic toner that contains a magnetic material or a non-magnetic toner that does not contain a magnetic material.

External additive particles may be externally added to the toner for various purposes. For example, an inorganic oxide may be added. Examples of the inorganic oxide particles include silica, titanium oxide, metatitanic acid, aluminum oxide, magnesium oxide, alumina, barium titanate, magnesium titanate, calcium titanate, strontium titanate, zinc oxide, zinc stannate, chromium oxide, antimony trioxide, and zirconium oxide particles.

When a toner is to contain an external additive, toner particles and an external additive are mixed with each other in a Henschel mixer, V blender, or the like. When toner particles are produced by a wet method, addition of the external additive may be conducted by a wet method.

### [Image Forming Apparatus]

An image forming apparatus that uses the electrophotographic developer of the exemplary embodiment is described below.

The image forming apparatus includes an image-carrying member, a charging device configured to charge a surface of the image-carrying member, a latent image forming device configured to form an electrostatic latent image on the surface of the image-carrying member, a developing device configured to develop the electrostatic latent image with the toner in the electrophotographic developer of the aforementioned exemplary embodiment so as to form a toner image, and a transfer device configured to transfer the toner image on the image-carrying member onto a surface of a receiving member. If needed, the image forming apparatus may further include other devices such as a cleaning device that includes a cleaning member that slides on the latent image carrying member so as to clean the components that remain after the transfer.

A non-limiting example of the image forming apparatus of the exemplary embodiment is described below. Only the relevant components illustrated in the drawings are described below.

Note that according to this image forming apparatus, a portion that includes the developing device may be formed to have a cartridge structure (process cartridge) removably attachable to the image forming apparatus main body, for example. A process cartridge that includes a developer-carrying member and accommodates the electrophotographic developer may be used as this process cartridge.

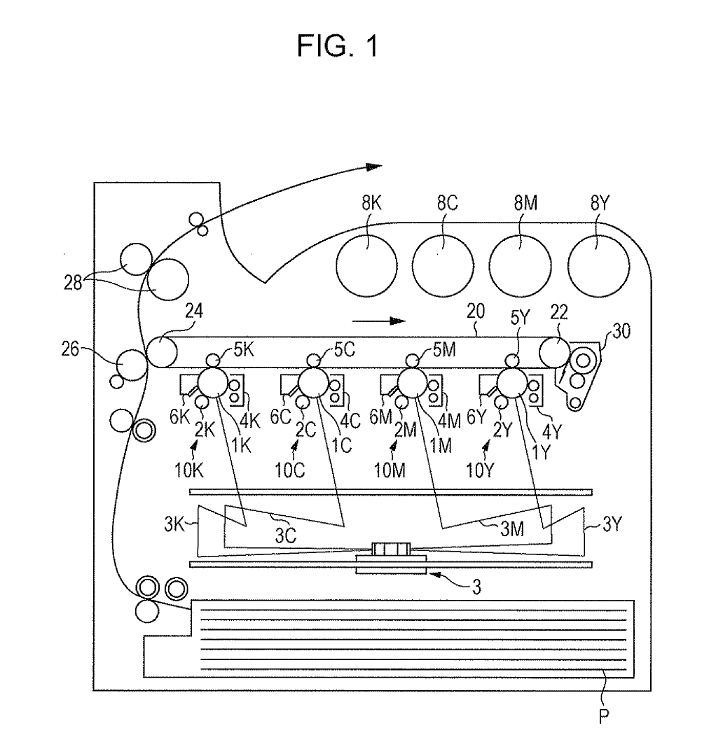

FIG. 1 is a schematic diagram showing a color image forming apparatus of a four-drum tandem system, which is one example of the image forming apparatus. The image forming apparatus shown in FIG. 1 includes first to fourth electrophotographic image forming units (image-forming apparatus) 10Y, 10M, 10C, and 10K that respectively output yellow (Y), magenta (M), cyan (C), and black (K) images on the basis of color-separated image data. The image forming units (referred to as “units” hereinafter) 10Y, 10M, 10C, and 10K are arranged side-by-side in the horizontal direction at predetermined intervals. The units 10Y, 10M, 10C, and 10K may be configured as a process cartridge removably attachable to the main body of the image forming apparatus.

An intermediate transfer belt 20 that functions as an intermediate transfer member is located above the units 10Y, 10M, 10C, and 10K in the drawing. The intermediate transfer belt 20 is stretched over a driving roller 22 and a support roller 24 in contact with the inner surface of the intermediate transfer belt 20. The driving roller 22 and the support roller 24 are apart from each other in the direction that extends from the left side of the drawing to the right side of the drawing. The intermediate transfer belt 20 is configured to run in the direction from the first unit 10Y to the fourth unit 10K. The support roller 24 is urged in the direction away from the driving roller 22 with a spring or the like not shown in the drawing. A predetermined tension is applied in advance to the intermediate transfer belt 20 stretched over the two rollers. An intermediate transfer member cleaning device 30 opposing the driving roller 22 is provided on the image carrying member-side of the intermediate transfer belt 20.

Yellow, magenta, cyan, and black toners in toner cartridges 8Y, 8M, 8C, and 8K are respectively supplied to developing devices 4Y, 4M, 4C, and 4K of the units 10Y, 10M, 10C, and 10K.

Since the first to fourth units 10Y, 10M, 10C, and 10K have identical structures, the first unit 10Y configured to form an yellow image and disposed on the upstream side in the intermediate transfer belt running direction is described as a representative example. The descriptions of the second to fourth units 10M, 10C, and 10K are omitted by giving reference numerals having magenta (M), cyan (C), and black (K) attached to the numerals.

The first unit 10Y includes a photoconductor 1Y functioning as a latent image-carrying member. A charging roller 2Y that charges the surface of the photoconductor 1Y to a predetermined potential, an exposing device 3 that forms an electrostatic latent image by exposing the charged surface with a laser beam 3Y on the basis of a color-separated image signal, a developing device 4Y that develops the electrostatic latent image by supplying a charged toner to the electrostatic latent image, a primary transfer roller 5Y that transfers the developed toner image onto the intermediate transfer belt 20, and a photoconductor cleaning device 6Y that removes the toner remaining on the surface of the photoconductor 1Y after the primary transfer are provided around the photoconductor 1Y.

The primary transfer roller 5Y is disposed on the inner side of the intermediate transfer belt 20 and opposes the photoconductor 1Y. Bias power supplies (not shown in the drawing) that apply a primary transfer bias are respectively connected to the primary transfer rollers 5Y, 5M, 5C, and 5K. The bias power supplies change the transfer bias applied to the primary transfer rollers by being controlled by a controller not shown in the drawing.

Operation of forming an yellow image by using the first unit 10Y will now be described. Prior to operation, the surface of the photoconductor 1Y is charged to a potential of −600 V to −800 V by using the charging roller 2Y.

The photoconductor 1Y is formed by layering a photosensitive layer on an electrically conductive (volume resistivity at 20° C.: 1×10⁻⁶ Ω·cm or less) substrate. The photosensitive layer normally has a high resistivity (a resistivity of common resin) but when irradiated with the laser beam 3Y, the resistivity of the portion irradiated with the laser beam changes. The laser beam 3Y is output to the charged surface of the photoconductor 1Y through the exposing device 3 in accordance with the yellow image data transmitted from the controller (not shown). The laser beam 3Y hits the photosensitive layer on the surface of the photoconductor 1Y and an electrostatic latent image of a yellow print pattern is thereby formed on the surface of the photoconductor 1Y.

An electrostatic latent image is an image formed on the surface of the photoconductor 1Y by charge. A portion of the photosensitive layer irradiated with the laser bean 3Y exhibits a lower resistivity and thus the charges in that portion flow out while charges remain in the rest of the photosensitive layer not irradiated with the laser beam 3Y. Since the electrostatic latent image is formed by such residual charges, it is a negative latent image.

The electrostatic latent image formed on the photoconductor 1Y is rotated to a predetermined developing position. The electrostatic latent image on the photoconductor 1Y is visualized (toner image) with the developing device 4Y at this developing position.

The developing device 4Y accommodates a yellow toner. The yellow toner is frictionally charged as it is stirred in the developing device 4Y and carried on the developer roller (developer-carrying member) by having charges having the same polarity (negative) as the charges on the photoconductor 1Y. As the surface of the photoconductor 1Y passes by the developing device 4Y, the yellow toner electrostatically adheres on the latent image portion on the photoconductor 1Y from which charges are removed and the latent image is thereby developed with the yellow toner. The photoconductor 1Y on which the yellow toner image is formed is continuously moved at a predetermined velocity to transport the developed toner image on the photoconductor 1Y to a predetermined primary transfer position.

After the yellow toner image on the photoconductor 1Y is transported to the primary transfer position, a predetermined primary transfer bias is applied to the primary transfer roller 5Y. Electrostatic force working from the photoconductor 1Y toward the primary transfer roller 5Y also works on the toner image and the toner image on the photoconductor 1Y is transferred onto the intermediate transfer belt 20. The transfer bias applied at this time has a polarity opposite to that (negative) of the toner, i.e., the polarity of the transfer bias is positive. For example, the transfer bias for the first unit 10Y is controlled to about +10 μA by the controller (not shown).

The toner remaining on the photoconductor 1Y is removed by the cleaning device 6Y and collected.

The primary transfer bias applied to the primary transfer rollers 5M, 5C, and 5K of the second to fourth units 10M to 10K are also controlled as with the first unit.

The intermediate transfer belt 20 onto which the yellow toner image has been transferred by using the first unit 10Y is transported through the second to fourth units 10M, 10C, and 10K. Toner images of other colors are superimposed on the yellow toner image to achieve multiple transfer.

The intermediate transfer belt 20 onto which the toner images of four colors are transferred using the first to fourth units then reaches a secondary transfer section constituted by the intermediate transfer belt 20, the support roller 24 in contact with the intermediate transfer belt inner surface, and the secondary transfer roller (secondary transfer device) 26 disposed on the image carrying surface side of the intermediate transfer belt 20. Meanwhile, a recording sheet P (receiving member) is supplied at a predetermined timing from a supplying mechanism to a space where the secondary transfer roller 26 and the intermediate transfer belt 20 contact each other, and a predetermined secondary transfer bias is applied to the support roller 24. The transfer bias applied has the same polarity as the toner (negative). The electrostatic force from the intermediate transfer belt 20 toward the recording sheet P works on the toner image, and the toner image on the intermediate transfer belt 20 is transferred onto the recording sheet P. The secondary transfer bias is determined by the resistance of the second transfer section detected with a resistance detector (not shown) and is controlled by voltage.

Subsequently, the recording sheet P is sent to the fixing device 28. The superimposed toner images are heated, melted, and fixed on the recording sheet P. The recording sheet P upon completion of the fixing of the color image is transported toward the discharging unit to terminate a series of color image forming operations.

Although the image forming apparatus has a structure in which toner images are transferred onto the recording sheet P by using the intermediate transfer belt 20, the structure is not limited to this. Alternatively, toner images may be directly transferred from the photoconductor onto the recording sheet.

### [Process Cartridge]

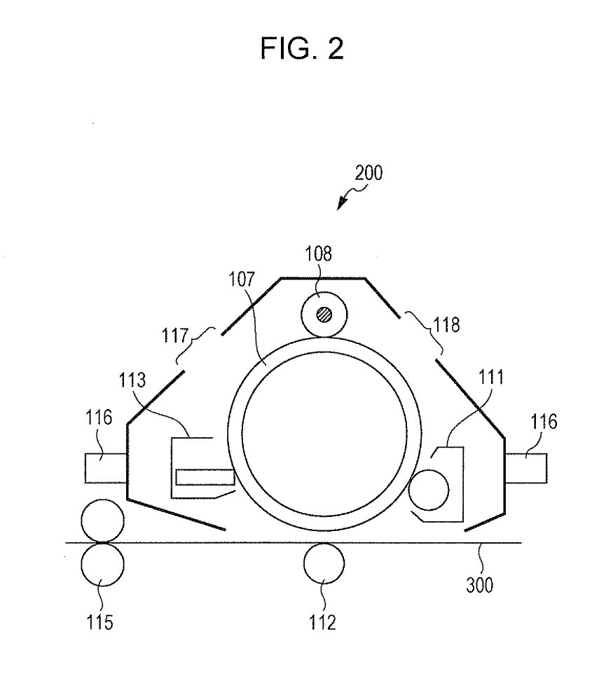

FIG. 2 is schematic diagram showing an exemplary embodiment of a process cartridge accommodating the electrophotographic developer of the exemplary embodiment. A process cartridge 200 includes a photoconductor 107, a charging roller 108, a developing device 111, a photoconductor cleaning device (cleaning device) 113, an opening 118 for exposure, and an opening 117 for charge erasing exposure combined on and integrated with an assembly rail 116. In FIG. 2, reference numeral 300 denotes a receiving member.

The process cartridge 200 is removably attachable to the image forming apparatus main body constituted by a transfer device 112, a fixing device 115, and other structural components not shown in the drawing. The process cartridge 200 forms the image forming apparatus together with the image forming apparatus main body.

The process cartridge 200 shown in FIG. 2 includes the photoconductor 107, the charging roller 108, the developing device 113, the opening 118 for exposure, and the opening 117 for erasing exposure in addition to the developing device 111. These devices may be selectively combined. The process cartridge of this exemplary embodiment may include the developing device 111 and at least one selected from the photoconductor 107, the charging roller 108, the photoconductor cleaning device 113, the opening 118 for exposure, and the opening 117 for erasing exposure.

### EXAMPLES

The present invention will now be described by using Examples below which do not limit the scope the present invention. In the following description, “parts” means “parts by mass” unless otherwise noted.

### Example 1

### <Synthesis of Tin-Zinc Complex Oxide Powder and Lowering the Resistivity Thereof (1)>

ZnSnO₃ (white powder) which is a tin-zinc complex oxide powder is synthesized by the following method.

First, 66 parts of sodium stannate trihydrate (produced by Wako Pure Chemical Industries, Ltd.) is dissolved in pure water. In an aqueous hydrochloric acid solution, 34 parts of zinc chloride (produced by Wako Pure Chemical Industries, Ltd.) is dissolved, and the resulting solution is poured into the solution of the sodium stannate trihydrate. The mixture is then stirred at 150 rpm for 30 minutes with a three-one motor (HEIDON BL600 produced by Shinto Scientific Co., Ltd.). The precipitates are washed with water and filtered, and this is repeated until the electrical conductivity is 10 mS/m or less. The precipitates are then dried at 200° C.

Zirconia beads 1 mm in size are placed in a planetary ball mill, and 65 parts of ZnSnO₃ obtained as above and 35 parts of ethanol are added to the planetary ball mill. After crushing for three hours, the sample is heat-treated in air at 500° C. The area-average particle size measured through SEM observation is 300 nm.

The sample is then heat-treated at 500° C. for 1 hour under reduced pressure of 1 kPa using a device for conducting reduced-pressure heating (high-temperature vacuum tube atmospheric electric furnace produced by Full-Tech Corporation). As a result, Sample 1 is obtained.

### —Measurement of Volume Resistivity—

The volume resistivity of ZnSnO₃ is measured before and after the heat treatment with a powder resistivity meter (MCP-PD51) produced by Mitsubishi Analytech Co., Ltd., in accordance to the method described above. The volume resistivity before heat treatment is 10⁹ Ω·cm and that after heat treatment is 3×10² Ω·cm. This shows that the resistivity is lowered.

### —X-Ray Diffractometry—

Sample 1 after the heat treatment is subjected to X-ray diffractometry using an X-ray diffractometer (D8 DISCOVER produced by Bruker AXS). The measurement has found that Sample 1 is amorphous.

### —Color—

The color of Sample 1 after the heat treatment is white to a light-color close to a flesh color. A color evaluation patch is made as below to evaluate this color.

Into a 0.1 mg/ml polyester resin solution, a 0.1 mg/ml solution of heat-treated Sample 1 is mixed to prepare a sample solution. The sample solution is subjected to suction filtration using a filter produced by Millipore K.K. (diameter: 47 mm, pore diameter: 0.05 μm, cellulose) to form a toner binder layer (area: 10 cm²). Then the toner binder layer is air-dried and thermally fixed at 120° C. to prepare a color evaluation patch sample. The color of the color evaluation patch sample is measured with x-rite 939 (produced by X-Rite, Incorporated). The color of the aforementioned filter produced by Millipore K.K. only is also measured as a reference. The color difference ΔE between the reference and the color evaluation patch sample is calculated from equation (1) below.

ΔE=((ΔL*)²+(Δa*)²+(Δb*)²)^{1/2} equation (1)

(in equation (1), ΔL*=L*_{reference}−L*ₛₐₘₚₗₑ, Δa*=a*_{reference}−a*ₛₐₘₚₗₑ, and Δb*=b*_{reference}−b*ₛₐₘₚₗₑ.)

The color difference between the color evaluation patch sample and the reference is 5.

### Example 2

### <Synthesis of Tin-Zinc Complex Oxide Powder and Lowering the Resistivity Thereof (2)>

ZnSnO₃ synthesized and crushed as in Example 1 is heat-treated at 900° C. and a reduced pressure of 1 kPa for 1 hour using the device used in Example 1. As a result, Sample 2 is obtained. The area-average particle size measured through SEM observation is 600 nm.

### —Measurement of Volume Resistivity—

The volume resistivity of Sample 2 measured after the heat treatment is 1×10³ Ω·cm. A lower resistivity is achieved.

### —X-Ray Diffractometry—

Sample 2 is analyzed by X-ray diffractometry using the device used in Example 1. Sample 2 is identified to be Zn₂SnO₄ and SnO₂.

### —Color—

The color of Sample 2 after the heat treatment is white to a light-color close to a flesh color. A color evaluation patch sample is prepared as in Example 1 to evaluate the color. The color difference between the sample and the reference is 6.

### Example 3

### <Synthesis of Tin-Zinc Complex Oxide Powder and Lowering the Resistivity Thereof (3)>

Zn₂SnO₄, which is a tin-zinc complex oxide powder, is produced by a chemical synthetic method (carbonate method). In particular, 7.4 g of zinc nitrate hexahydrate produced by Wako Pure Chemical Industries, Ltd., is dissolved in 50 ml of pure water, and 2.8 g of tin chloride dihydrate produced by Wake Pure Chemical Industries, Ltd., is dissolved in 50 ml of a 2M aqueous hydrochloric acid solution. The resulting latter solution is mixed with the former aqueous zinc nitrate solution. To this mixture, a 0.5 M/L sodium carbonate solution is added until pH is 7, followed by stirring for 30 minutes. Precipitates are separated by repeating washing with pure water and filtration until the electrical conductivity of the filtrate is 10 mS/m or less, dried at 100° C., and heat-treated at 900° C. for 1 hour in air.

The sample is crushed as in Example 1.

The crushed sample is heat-treated at 900° C. and a reduced pressure of 1 kPa for 1 hour using the device used in Example 1. As a result, Sample 3 is obtained. The area-average particle size measured through SEM observation is 500 nm.

### —Measurement of Volume Resistivity—

The volume resistivity of Sample 3 measured after the heat treatment is 2×10³ Ω·cm.

### —X-Ray Diffractometry—

Sample 3 is analyzed by X-ray diffractometry using the device used in Example 1. Sample 3 is identified as having a Zn₂SnO₄ single phase.

### —Color—

A color evaluation patch sample is prepared as in Example 1 to evaluate the color of Sample 3 after the heat treatment. The color difference between the sample and the reference is 5.

### Example 4

### <Synthesis of Tin-Zinc Complex Oxide Powder and Lowering the Resistivity Thereof (4)>

ZnSnO₃, which is a tin-zinc complex oxide powder, is produced by a chemical synthetic method (carbonate method). In particular, 8.9 g of zinc nitrate hexahydrate produced by Wako Pure Chemical Industries, Ltd., is dissolved in 50 ml of pure water, and 6.7 g of tin chloride dihydrate produced by Wako Pure Chemical Industries, Ltd., is dissolved in 50 ml of a 2M aqueous hydrochloric acid solution. The resulting latter solution is mixed with the former aqueous zinc nitrate solution. To this mixture, a 0.5 M/L sodium carbonate solution is added until pH is 7, followed by stirring for 30 minutes. Precipitates are separated by repeating washing with pure water and filtration until the electrical conductivity of the filtrate is 10 mS/m or less, dried at 100° C., and heat-treated at 500° C. for 1 hour in air.

The sample is crushed as in Example 1.

The crushed sample is heat-treated at 500° C. and a reduced pressure of 1 kPa for 1 hour using the device used in Example 1. As a result, Sample 4 is obtained. The area-average particle size measured through SEM observation is 300 nm.

### —Measurement of Volume Resistivity—

The volume resistivity of Sample 4 measured after the heat treatment is 2×10² Ω·cm.

### —X-Ray Diffractometry—

Sample 4 is analyzed by X-ray diffractometry using the device used in Example 1. Sample 4 is identified as amorphous.

### —Color—

The color of Sample 4 after the heat treatment is white to a light-color close to a flesh color. A color evaluation patch sample is prepared as in Example 1 to evaluate the color. The color difference between the sample and the reference is 5.

### Comparative Example 1

A conductive oxide (Passtran 6010, tin oxide base) produced by Mitsui Mining & Smelting Co., Ltd., is prepared as a conductive material. This is referred to as “Comparative Sample 1”.

### —Measurement of Volume Resistivity—

The volume resistivity of Comparative Sample 1 measured is 1×10¹ Ω·cm.

### —Color—

A color evaluation patch sample is prepared as in Example 1 to evaluate the color of Comparative Sample 1. The color difference between the sample and the reference is 24.

TABLE 1

| | | Heat | | | | | |
|---|---|---|---|---|---|---|---|
| | | treatment | Volume | | Particle | | |
| | Conductive | temperature | resistivity | | size after | | Color |
| | agent | [° C.] | [Ω · cm] | Amorphous | crushing | Color | difference |
| Example 1 | ZnSnO₃ | 500° C. | 3 × 10² | Yes | 300 nm | White | 5 |
| | | | | | | to flesh | |
| Example 2 | Zn₂SnO₄ + | 900° C. | 1 × 10³ | No | 600 nm | White | 6 |
| | SnO₂ | | | | | to flesh | |
| Example 3 | Zn₂SnO₄ | 900° C. | 2 × 10³ | No | 500 nm | White | 5 |
| | | | | | | to flesh | |
| Example 4 | ZnSnO₃ | 500° C. | 2 × 10² | Yes | 300 nm | White | 5 |
| | | | | | | to flesh | |
| Comparative | Tin oxide | None | 1 × 10¹ | No | — | Brown | 24 |
| Example 1 | base | | | | | | |

### Example 5 to 6 and Comparative Example 2

### <Lowering the Resistivity of Tin-Zinc Complex Oxide Powder (5) to (7)>

ZnSnO₃ prepared as in Example 1 before reduced-pressure heating is heat-treated at 400° C. (Comparative Example 2), 450° C. (Example 5), and 600° C. (Example 6) and a reduced pressure of 1 kPa for 1 hour using the device used in Example 1. As a result, Samples 5 to 7 are obtained. The volume resistivity and the color difference of Samples 5 to 7 after the heat treatment are shown in Table 2.

Peaks attributable to Zn₂SnO₄ have begun to appear when heat treatment is conducted under reduced pressure of 1 kPa and a temperature exceeding 650° C. for 1 hour.

TABLE 2

| | Heat treatment | Volume | Color |
|---|---|---|---|
| | temperature [° C.] | resistivity [Ω · cm] | difference |
| Comparative | 400° C. | 1 × 10⁷ | 6 |
| Example 2 | | | |
| Example 5 | 450° C. | 5 × 10² | 6 |
| Example 1 | 500° C. | 3 × 10² | 5 |
| Example 6 | 600° C. | 2 × 10² | 5 |

### Examples 7 to 11 and Comparative Examples 3 to 5

### <Lowering the Resistivity of Tin-Zinc Complex Oxide Powder (8) to (15)>

ZnSnO₃ prepared as in Example 1 before reduced-pressure heating is heat-treated at 500° C. and a degree of vacuum indicated in Table 3 for 1 hour using the device used in Example 1. As a result, Samples 8 to 15 are obtained. The volume resistivity and the color difference of Samples 8 to 15 after the heat treatment are shown in Table 3.

TABLE 3

| | Degree of | Volume | Color |
|---|---|---|---|
| | vacuum [Pa] | resistivity [Ω · cm] | difference |
| Comparative | 120 | 3 × 10⁶ | 6 |
| Example 3 | | | |
| Example 7 | 180 | 2 × 10⁴ | 7 |
| Example 8 | 250 | 7 × 10² | 10 |
| Example 9 | 670 | 3 × 10² | 12 |
| Example 10 | 1 k | 2 × 10² | 12 |
| Example 11 | 3 k | 2 × 10² | 12 |
| Comparative | 4 k | 1 × 10⁷ | 3 |
| Example 4 | | | |
| Comparative | 101 k (air) | 9 × 10⁶ | 2 |
| Example 5 | | | |

### Examples 12 to 14 and Comparative Example 6

### <Lowering the Resistivity of Tin-Zinc Complex Oxide Powder (16) to (19)>

ZnSnO₃ prepared as in Example 2 before reduced-pressure heating is heat-treated at 900° C. and a degree of vacuum indicated in Table 4 for 1 hour using the device used in Example 1. As a result, Samples 16 to 19 are obtained. The volume resistivity and the color difference of Samples 16 to 19 after the heat treatment are shown in Table 4.

TABLE 4

| | Degree of | Volume | Color |
|---|---|---|---|
| | vacuum [Pa] | resistivity [Ω · cm] | difference |
| Example 12 | 10 | 5 × 10⁴ | 6 |
| Example 13 | 120 | 2 × 10⁴ | 6 |
| Example 14 | 1 k | 6 × 10³ | 6 |
| Comparative | 101 k (air) | 3 × 10⁶ | 2 |
| Example 6 | | | |

### Comparative Examples 7 and 8

### <Synthesis of Tin-Zinc Complex Oxide Powder>

ZnSnO₃, which is a tin-zinc complex oxide powder, is produced by a chemical synthetic method (carbonate method). In particular, 8.9 g of zinc nitrate hexahydrate produced by produced by Wako Pure Chemical Industries, Ltd., is dissolved in 50 ml of pure water, and 6.7 g of tin chloride dihydrate produced by Wako Pure Chemical Industries, Ltd., is dissolved in 50 ml of a 2M aqueous hydrochloric acid solution. The resulting latter solution is mixed with the former aqueous zinc nitrate solution. To this solution, 0.5 M/L sodium carbonate solution is added until pH is 7, followed by stirring for 30 minutes. Precipitates are separated by repeating washing with pure water and filtration until the electrical conductivity of the filtrate is 10 mS/m or less, dried at 100° C., and heat-treated at 900° C. for 1 hour in air. As a result, Sample 20 is obtained. The volume resistivity of Sample 20 measured is 1×10⁷ Ω·cm.

Sample 20 is heat-treated at 900° C. for 1 hour in an Ar atmosphere (Comparative Example 7) and a N₂ atmosphere (Comparative Example 8). The volume resistivity of each sample measured is 1×10⁷ Ω·cm. The color difference is 3 in both comparative examples.

### <Evaluation: Production of Carrier and Formation of Image>

### —Preparation of Carrier—

Samples of Examples 1 to 3 and Comparative Example 1 are used as a conductive agent to form carriers.

First, Mn—Mg—Sr ferrite particles (volume-average particle size: 35 μm) are used as the core. Samples of Examples and Comparative Examples are used as a conductive agent. To 3 parts of a cyclohexyl methacrylate-methacrylate copolymer resin as a resin for the coating layer and 20 parts of a toluene as a solvent, 100 parts of the core and 0.8 parts of the conductive agent are added. The mixture is placed in a vacuum degassing kneader and stirred for 30 minutes under heating at 70° C. to remove the solvent by stirring under reduced pressure. The produced sample is sieved through a 75 μm mesh to obtain a carrier.

### —Preparation of Toner—

### Preparation of Emulsion (Amorphous Resin Latex (A1))

In a nitrogen atmosphere, 97.1 parts of dimethyl terephthalate, 58.3 parts of isophthalic acid, 53.3 parts of dodecenylsuccinic anhydride, 94.9 parts of bisphenol A ethylene oxide adduct, 241 parts of bisphenol A propylene oxide adduct, and 0.12 parts of dibutyltin oxide are stirred at 180° C. for 6 hours. The mixture is then stirred at 220° C. for 5 hours under reduced pressure, and 8 parts of trimellitic anhydride is added to the mixture after the molecular weight reached 30000, followed by stirring for 2 more hours. As a result, resin A1 which is an amorphous polyester having a weight-average molecular weight Mw of 45900 and a number-average molecular weight Mn of 7900 is obtained.

Into 120 parts of ethyl acetate and 75 parts of isopropyl alcohol, 300 parts of resin A1 is dissolved at 25° C., and 10.4 parts of 10% ammonia water is added to the solution. To this mixture, 1200 parts of ion exchange water is slowly added dropwise to cause phase inversion. Then ethyl acetate is distilled away from the emulsion obtained thereby. As a result, an amorphous resin latex (A1) having a volume-average particle size of 0.17 μm is obtained.

Preparation of Emulsion (Amorphous Resin Latex (B1))

In a nitrogen atmosphere, 97.1 parts of dimethyl terephthalate, 38.8 parts of isophthalic acid, 79.9 parts of dodecenylsuccinic anhydride, 94.9 parts of bisphenol A ethylene oxide adduct, 241 parts of bisphenol A propylene oxide adduct, and 0.12 parts of dibutyltin oxide are stirred at 180° C. for 6 hours. The mixture is then stirred at 220° C. for 2 hours under reduced pressure, and 9 parts of trimellitic anhydride is added to the mixture after the molecular weight reached 12000, followed by stirring for 1 more hour. As a result, resin B1 which is an amorphous polyester having a weight-average molecular weight Mw of 14500 and a number-average molecular weight Mn of 5300 is obtained.

Into 120 parts of ethyl acetate and 75 parts of isopropyl alcohol, 300 parts of resin B1 is dissolved at 25° C., and 10.4 parts of 10% ammonia water is added to the solution. To this mixture, 1200 parts of ion exchange water is slowly added dropwise to cause phase inversion. Then ethyl acetate is distilled away from the emulsion obtained thereby. As a result, an amorphous resin latex (B1) having a volume-average particle size of 0.15 μm is obtained.

Preparation of Emulsion (Crystalline Resin Latex (C1))

In a nitrogen atmosphere, 230.3 parts of dodecanedioic acid, 160.3 parts of 1,9-nonanediol, and 0.12 parts of dibutyltin oxide are stirred at 180° C. for 6 hours. Then stirring is continued for 4 hours under reduced pressure. As a result, resin C1 which is a crystalline polyester resin having a weight-average molecular weight Mw of 24200 and a number-average molecular weight Mn of 9900 is obtained.

Into 105 parts of ethyl acetate and 105 parts of isopropyl alcohol, 300 parts of resin C1 is dissolved at 65° C., and 15.5 parts of 10% ammonia water is added to the solution. To this mixture, 1200 parts of ion exchange water is slowly added dropwise to cause phase inversion. Then ethyl acetate is distilled away from the emulsion obtained thereby. As a result, a crystalline resin latex (C1) having a volume-average particle size of 0.13 μm is obtained.

### Preparation of Pigment Dispersion

Materials below are mixed, dissolved, and dispersed with a homogenizer (ULTRA-TURRAX T50 produced by IKA) under ultrasonic radiation to prepare a black pigment dispersion having a volume-average particle size of 150 nm.

Carbon black pigment R330 (produced by CABOT): 50 parts

Anionic surfactant, Neogen SC: 5 parts

Ion exchange water: 200 parts

### Preparation of Releasing Agent Dispersion

Materials below are mixed, heated to 97° C., and dispersed with a homogenizer (ULTRA-TURRAX T50 produced by IKA). The resulting dispersion is further dispersed and processed 20 times with Gaulin homogenizer (produced by Meiwa Shoji Co., Ltd.) at 105° C. and 550 kg/cm², to reduce the particle size. As a result, a releasing agent dispersion having a volume-average particle diameter of 190 nm is obtained.

Wax (WEP-5 produced by NOF Corporation): 50 parts

Anionic surfactant, Neogen SC: 5 parts

Ion exchange water: 200 parts

### Preparation of Electrophotographic Toner

Materials below are mixed and dispersed with a homogenizer (ULTRA-TURRAX T50 produced by IKA) in a spherical stainless steel flask.

Amorphous resin latex (A1): 195 parts

Amorphous resin latex (B1): 195 parts

Crystalline resin latex (C1): 52 parts

Ion exchange water: 250 parts

Pigment dispersion: 33.5 parts

Releasing agent dispersion: 67.5 parts

Cross-linking agent (oxazoline-containing cross-linking agent, EPOCROS WS-500): 1.8 parts

Then 75 parts of a 10% aqueous aluminum sulfate solution is added to the flask, and the content of the flask is heated to 45° C. under stirring and retained at 45° C. for 30 minutes (preparation of the core).

Then 105 parts of amorphous resin latex (A1) and 105 parts of amorphous resin latex (B1) are further added, followed by stirring for 30 minutes. The obtained content is observed with an optical microscope. Formation of agglomerated particles having a particle size of 6.5 μm has been confirmed. The pH of the content is adjusted to 7.5 with an aqueous sodium hydroxide solution. The temperature of the mixture is increased to 90° C. and the agglomerated particles are coalesced in 2 hours. The coalesced particles are cooled, filtered, thoroughly washed with ion exchange water, and dried to prepare an electrophotographic toner.

### —Preparation of Image Developer—

In a V-type blender, 100 parts of the carrier and 8 parts of the toner are stirred for 20 minutes to prepare a developer.

### —Formation of Image—

The obtained developer is mounted in an image forming apparatus (DocuPrint 2220 produced by Fuji Xerox Co., Ltd.), and an image is formed. The image is evaluated by observation with naked eye.

Compared to images formed by using carriers prepared by using Comparative Sample 1 of Comparative Example 1, images formed by using carriers prepared by using Samples 1 to 3 of Examples 1 to 3 have fewer image defects caused by flaking of the coating layer of the carrier and deterioration of the hue in halftone images is suppressed, resulting in high image quality.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A tin-zinc complex oxide powder comprising particles containing a tin-zinc complex oxide and having a volume resistivity of about 1×10⁵ Ω·cm or less.

2. The tin-zinc complex oxide powder according to claim 1, wherein the tin-zinc complex oxide is substantially amorphous.

3. The tin-zinc complex oxide powder according to claim 1, wherein the particles have an area-average particle size of about 10 to 5000 nm.

4. The tin-zinc complex oxide powder according to claim 2, wherein the particles have an area-average particle size of about 10 to 5000 nm.

5. The tin-zinc complex oxide powder according to claim 1, wherein the particles are heat-treated at about 450° C. to 900° C. under reduced pressure.

6. The tin-zinc complex oxide powder according to claim 5, wherein a degree of vacuum during the heat treatment is about 10 Pa to 3 kPa.

7. A method for producing a tin-zinc complex oxide powder, the method comprising:
heat-treating tin-zinc complex oxide particles at about 450° C. to 900° C. under reduced pressure, wherein the tin-zinc complex oxide powder obtained thereby is the tin-zinc complex oxide powder according to claim 1.

8. The method according to claim 7, wherein a degree of vacuum during the heat treatment is about 10 Pa to 3 kPa.

9. An electrophotographic carrier comprising:
a core including a magnetic material; and
a coating layer on the core, wherein the coating layer contains tin-zinc complex oxide particles having a volume resistivity of about 1×10⁵ 106 ·cm or less.

10. The electrophotographic carrier according to claim 9, wherein the tin-zinc complex oxide particles are substantially amorphous.

11. The electrophotographic carrier according to claim 9, wherein the tin-zinc complex oxide particles have an area-average particle size of about 10 nm to 5000 nm.

12. The electrophotographic carrier according to claim 9, wherein the coating layer has a thickness of about 0.5 μm to 5 μm.

13. The electrophotographic carrier according to claim 9, wherein the core has a volume electrical resistivity in the range of about 1×10⁵ Ω·cm to 1×10¹⁰ Ω·cm.

14. The electrophotographic carrier according to claim 9, wherein the core has a volume-average particle size in the range of about 30 μm to 150 μm.

15. An electrophotographic developer comprising:
the electrophotographic carrier according to claim 9; and
an electrophotographic toner.

16. The electrophotographic developer according to claim 15, wherein the tin-zinc complex oxide particles are substantially amorphous.

17. The electrophotographic developer according to claim 15, wherein the tin-zinc complex oxide particles have an area-average particle size of about 10 nm to 5000 nm.

18. The electrophotographic developer according to claim 15, wherein the coating layer has a thickness of about 0.5 μm to 5 μm.

19. The electrophotographic developer according to claim 15, wherein the core has a volume electrical resistivity in the range of about 1×10⁵ Ω·cm to 1×10¹⁰ Ω·cm.

20. The electrophotographic developer according to claim 15, wherein the core has a volume-average particle size in the range of about 30 μm to 150 μm.
